(19) United States
(12) Patent Application Publication
(10) Pub. No.: US 2004/0182265 A1
(43) Pub. Date: Sep. 23, 2004

(54) Wiring substrate

(75) Inventors: Hajime Saiki, Niwa-gun (JP); Michitoshi Nakata, Tajimi-shi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 10/787,412

(22) Filed: Feb. 27, 2004

(30) Foreign Application Priority Data
Feb. 28, 2003 (JP) P.2003-054477
Jan. 30, 2004 (JP) P.2004-023495

(51) Int. Cl. G03C 5/18

(52) U.S. Cl. 101/366

(57) ABSTRACT

A wiring substrate, in which a wiring stacked portion including a conductor layer and a resin layer is stacked on a principal face of a core substrate including a substantially cylindrical through hole conductor in a through hole extending therethrough and a filling material filling the hollow portion of said through hole, comprising: a cover-shaped conductor portion covering an end face of said through hole just over a principal face of said core substrate and connected to said through hole conductor; and an initial conductor layer provided in said wiring stacked portion and across at least one of said resin layer from sad cover-shaped conductor layer, wherein a connection portion composed of via conductors buried in said resin layer brings said cover-shaped conductor portion and said internal conductor layer into conduction, and said via conductors composing said connection portion are provided not above said through hole.

### FIELD OF THE INVENTION

The present invention relates to a wiring substrate including a resin.

The wiring substrate is provided on its principal face with a number of pad-shaped electrodes to be used for mounting electronic parts such as an LSI or an IC chip thereon and on its other principal face with a number of terminal pad conductors (or electrodes) to be connected with a mother board and connection terminals (e.g., solder balls) disposed on the terminal pad conductors. The wiring resin substrate of this type is small-sized and increased in the connection terminal number (e.g., the ball number) so as to enhance the integration and density of the electronic parts such as the LSI, the IC chip or a chip capacitor to be mounted thereon.

This wiring resin substrate is generally provided with a wiring stacked portion composed of a conductor layer and a resin layer and lying on the principal face of a core substrate, which has a through hole conductors and a filling material in a through hole formed in an insulating substrate, and a via conductor for bringing the conductor layers into conduction is buried in the resin layer. As background arts, JP-A-2000-91383, JP-A-10-341080, JP-A-2000-307220 (Paragraphs [0014] and [0015]), JP-A-2000-340951 (Paragraphs [0014] and [0015]), JP-A-2001-53507, and JP-A-20-270483 are known.

### SUMMARY OF THE INVENTION

The wiring resin substrate thus far described is troubled by the following problem in the procedure of a beat cycle to be performed for manufacturing it. In a core substrate acting as the nuclei of the wiring resin substrate, a through hole conductor is formed at a predetermined position of an insulating substrate made of a resin or the like so as to bring the two principal faces into conduction. Since a metal and a resin have different coefficients of thermal expansion, the expansion/shrinkage in the thickness direction of the core substrate due to the beat cycle is deviated depending on the position. In the layer stacked on the core substrate, therefore, the force to be applied by the expansion/shrinkage of the core substrate becomes heterogeneous. As a result, a cracking occurs in the joint face or the like of a via conductor thereby to cause a problem that the electric connection between the conductor layers is easily broken. This problem leads to the fact that the qualities such as the electric characteristics required of the wiring resin substrate are not kept.

In order to solve that problem, therefore, the present invention has an object to provide a wiring substrate made of a resin including a conductor layer and a resin layer stacked on a core substrate and having highly reliable electric characteristics.

In order to solve the aforementioned problem, according to the invention, there is provided a wiring resin substrate, in which a wiring stacked portion including a conductor layer and a resin layer is stacked on the principal face of a core substrate having a substantially cylindrical through hole conductor in a through hole extending therethrough and a filling material filling the hollow portion of the through hole. The wiring resin substrate comprises: a cover-shaped conductor portion covering the end face of the through hole just over the principal face of the core substrate and connected to the through hole conductor; and an internal conductor layer formed in the wiring stacked portion and across at least one of the resin layer from the cover-shaped conductor layer. A connection portion composed of via conductors buried in the resin layer brings the cover-shaped conductor portion and the internal conductor layer into conduction. The via conductors composing the connection portion avoid the positions above the through hole.

Generally, a resin material has a larger coefficient of thermal expansion than that of a metallic material. In case a wiring resin substrate 501 is heated (as shown in FIG. 3A), a substantially cylindrical through hole conductor 22 (of a metallic material), a filling material 23 (of a resin-material) filling the hollow portion of the through hole conductors 22, and an insulating substrate material 25 (of a resin material, as located around the through hole conductor 22), all of which construct a core substrate 2, expand individually in the thickness direction. As shown in FIG. 3B, the expansion of the through hole conductor 22 is smaller than those of the surrounding resin materials 23 and 25. A cover-shaped conductor layer 4 connected to the through hole conductor 22 can hold the vicinity of the outer edge of the through hole conductor 22 so that the expansion of the filling material 23 is obstructed at that vicinity. As a result, the expansion of the filling material 23 is concentrated in the vicinity of the center axis of a through hole 21 to push up the cover-shaped conductor layer 4 and a resin layer 3 lying over the filling material 23. In case the wiring resin substrate 501 is cooled, on the other hand, a reverse phenomenon occurs so that the shrinkage of the filling material 23 is concentrated in the vicinity of the center axis of the through hole 21, as shown in FIG. 3C, to pull down the overlying cover-shaped conductor layer 4 and resin layer 3. Therefore, via conductors 61 and 62 are easily influenced, if they lie over the through hole 21, by the influences of the push-up or pull-down of the core substrate 2. An excessive stress concentration occurs between the cover-shaped conductor layer 4 and the via conductor 61, between the via conductors (i.e.. the via conductors 61 and 62) and between the via conductor 62 and an internal conductor layer 5 so that the cover-shaped conductor layer 4 and the via conductor 61 are liable to be electrically disconnected (FIG. 3C shows the case, in which the connection between the cover-shaped conductor layer 4 and the via conductor 61 is broken). Here, the wiring substrate of the related art has been unable to avoid that problem because the via conductors are arranged over the through hole so as to make the wiring highly dense.

As in the invention thus far described, therefore, the influences of the aforementioned push-up/pull-down from the core substrate can be hardly received by arranging the via conductors constructing the connection portion at the positions avoiding that above the through hole.

Next, in case the wiring resin substrate of the invention has two or more resin layers sandwiched between the cover-shaped conductor layer and the internal conductor layer, the connection portion of a stacked via structure can be constructed by burying the via conductors of filled vias individually in the resin layers and by making the via conductors substantially concentrically contiguous to each other in plurality. As described above, the via conductors are not positioned above the through hole and hardly receive the influences of the push-up/pull-down from the core substrate, so that the connection portion can be constructed as the stacked via structure. In this case, the inside space of the wiring stacked portion can be spared to retain the wiring area.

Next in the wiring resin substrate of the invention, the distance from the center axis of the via conductors constructing the connection portion to the outer edge of the through hole can be made 125 μm or more and 500 μm or less. In order to make it hard to receive the influences of the push-up/pull-down of the core substrate sufficiently over the through hole, it is preferred that the above-specified distance be 125 μm or more. On the other hand, the upper limit of that distance is not specifically limitative but is preferably 500 μm from the viewpoint of sparing the inside space of the wiring stacked portion and improving the wiring density.

Herein, the “center axis (or center axial line)” is oriented in the same direction as that for the through hole to extend through (i.e., the thickness direction of the core substrate) and passes the center position of the substantially circular projected image, which is formed by projecting the through hole, the via conductor and the terminal pad conductor individually on a plane normal to that through direction.

In the wiring substrate of the related art, the structure, in which a transmission line is arranged between a plurality of earthing conductor layers through a resin layer, is well known as the so-called “strip line structure”. On the other hand, the structure in which the transmission line is arranged as in the strip line structure between the earthing conductor layers through the resin layer and in which the earthing conductor layer is arranged on the plane common to the transmission line, is well known as the so-called “coplanar (or common planar type) structure”. In these strip line and coplanar structures, the transmission line is enclosed by the earthing conductor so as to keep the transmission line out of the influences of noises coming from the outside. Here in the coplanar structure, the electric characteristics are improved by reducing the crosstalk noises with another transmission line arranged on the common plane by earthing conductor lines formed on a common plane and on the two sides of the transmission line.

In recent years, moreover, trials have been made to prevent the influences of the noises more by connecting the individual earthing conductors (i.e. a plurality of earthing conductor layers in the strip line structure or pluralities of earthing conductor layers and earthing conductor lines in the coplanar structure) arranged around the transmission line by the via conductors and by enclosing the transmission line to keep the earthing conductor reliably at an equal potential (or the earth potential).

In case the earthing conductor layer is made of the aforementioned cover-shaped conductor on one side, however, there arise a problem that the predetermined electric connection between the stacked layers is broken by a push-up/pull-down of the core substrate like the aforementioned one, namely, that the earthing conductor enclosing the transmission line cannot be kept at an equal potential in the strip line structure or the coplanar structure. This problem makes it impossible to keep the qualities such as the electric characteristics required of the wiring resin substrate.

In the strip line structure or the coplanar structure, therefore, that problem can be solved by applying a structure similar to that of the aforementioned wiring resin substrate of the invention.

According to the invention, there is also provided a wiring resin substrate comprising: a core substrate including a through hole formed through an insulating substrate, a substantially cylindrical through hole conductors formed on the inner circumference of the through hole, and a filling material filling the hollow portion of the through hole conductors; a first earthing conductor layer formed on at least one principal face of the core substrate and in a shape containing the end face of the through hole and having conduction to the through hole conductor; a plurality of resin layers formed over the first earthing conductor layer; a transmission line formed between any ones of the resin layers and positioned above the first earthing conductor layer; a second earthing conductor layer formed over the resin layers and in a shape containing the transmission line; and a connection portion including either via conductors buried individually in the resin layers, or the via conductors and a third earthing conductor layer arranged between the same resin layers the case of the transmission line and having no conduction to the transmission line, the via conductors being formed to bring the first earthing conductor layer and the second earthing conductor layer into conduction. The via conductors to be connected to the first earthing conductor layer are so positioned in the connection portion as to avoid that above the through hole.

In the connection portion including either the via conductors or the via conductors and the third earthing conductor layer (or the earthing conductor line) and formed to bring the first earthing conductor layer and the second earthing conductor layer into conduction, as described above, the aforementioned influences of the expansion/shrinkage of the core substrate can be hardly received by making the construction, in which the via conductor (i.e., the via conductor buried in the lowermost one of a plurality of resin layers) to be connected with the first earthing conductor layer or the via conductor the closest to the through hole is not positioned above the through hole. Here, the structure, in which the connection portion is composed of the via conductors, implies the strip line structure, and the structure, in which the connection portion is composed of the via conductors and the third earthing conductor layer (or the earthing conductor line), implies the coplanar structure.

In the wiring resin substrate of the invention, moreover, the connection portion can be positioned not above the through hole and constructed either in the stacked via structure of the strip line structure, in which a plurality of filled vias are concentrically contiguous to each other, or in the structure of the coplanar structure, in which the third earthing conductor layer (or the earthing conductor line) is connected between any adjoining ones of the filled vias in the stacked via structure. Since the filled vias can be connected by arranging the via conductors thereover, all the via conductors composing the connection portion are so arranged in the construction that none of the via conductors composing the connection portion is positioned above the through hole thereby to hardly receive the expansion/shrinkage of the core substrate. In addition, the space can be spared to retain the wiring area by making the filled vias concentrically contiguous to each other.

### BRIEF DESCRIPTION OF TEE DRAWINGS

FIG. 1 is a diagram illustrating the internal structure of a wiring resin substrate having a microstrip line structure;

FIG. 2 is a diagram illustrating the internal structure of a wiring resin substrate having a coplanar structure;

FIGS. 3A to 3C are diagrams illustrating the influences on a connection portion by the expansion/shrinkage of a core substrate;

FIG. 4 is a schematic diagram of the entirety of the internal structure of the wiring resin substrate;

FIG. 5 tabulates the evaluation results of cracking percentages;

FIG. 6 is a diagram illustrating the internal structure of Comparison 2 having a coplanar structure;

FIG. 7 tabulates the evaluation results of resistance changing percentages;

FIGS. 8A and 8B are diagrams illustrating the internal structures of Example 3 and Comparison 3;

FIGS. 9A to 9D are schematic diagrams of a via joint evaluating method:

FIG. 10 tabulates the evaluation results of a via joint;

FIG. 11 is a schematic diagram illustrating the internal structure of a wiring resin substrate according to a first embodiment of the invention; and

FIG. 12 is a schematic diagram illustrating the internal structure of a wiring resin substrate according to a second embodiment of the invention.

### DESCRIPTION OF REFERENCE NUMERALS AND SIGNS

1, 101, 201, 301, 401, 501 WIRING RESIN SUBSTRATE

2 CORE SUBSTRATE

21 THROUGH HOLE

22 TROUGH HOLE CONDUCTOR

23 FILLING MATERIAL

3 RESIN LAYER

4 FIRST EARTHING CONDUCTOR LAYER (COVER-SHAPED CONDUCTOR LAYER)

5 SECOND EARTHING CONDUCTOR LAYER (INTERNAL CONDUCTOR LAYER)

6 CONNECTION PORTION

61 VIA CONDUCTOR (LOWER SIDE)

62 VIA CONDUCTOR (UPPER SIDE)

7 TRANSMISSION LINE

8 THIRD EARTHING CONDUCTOR LAYER (EARTHING CONDUCTOR LINE)

### DETAILED DESCRIPTION OF THE INVENTION

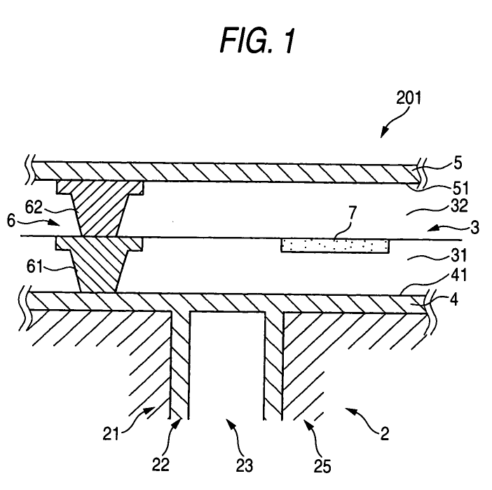

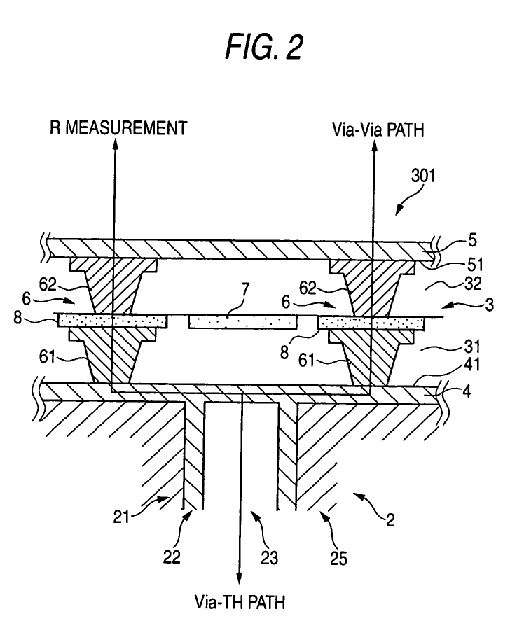

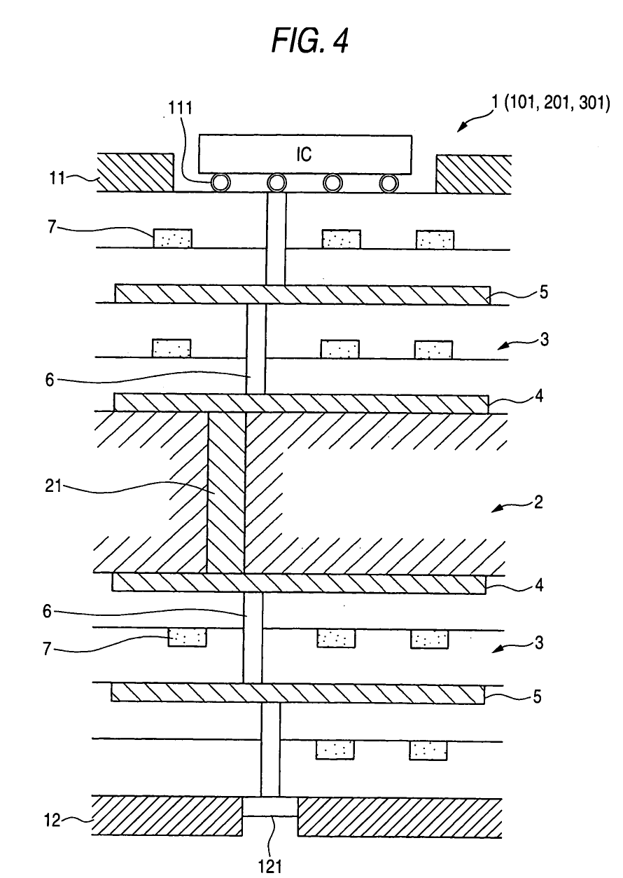

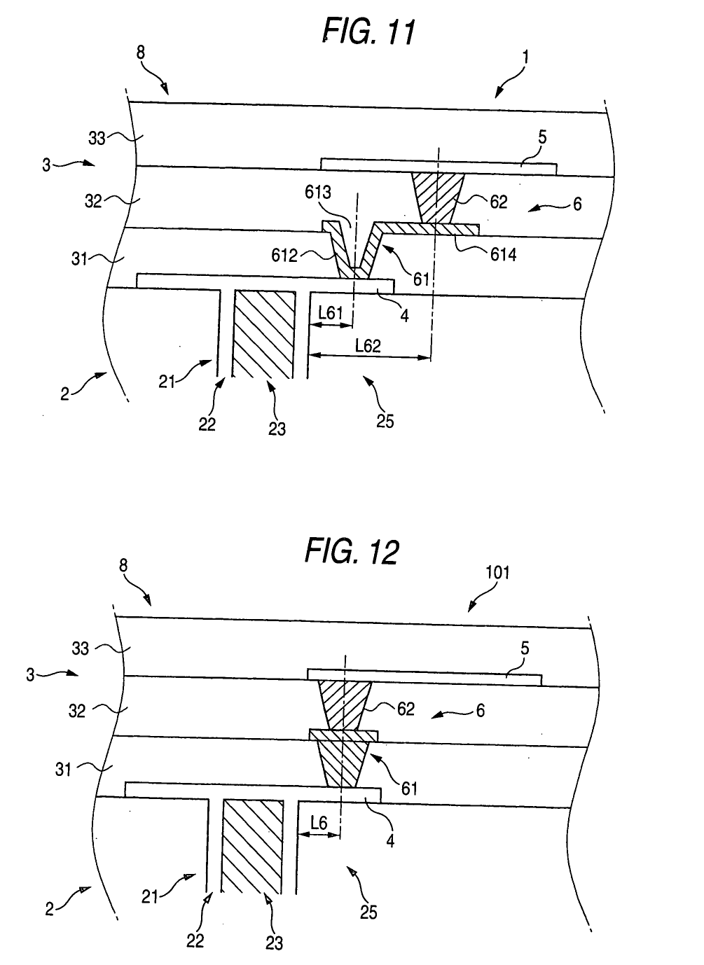

An embodiment of a wiring substrate made of a resin of the invention will be described with reference to the accompanying drawings. FIG. 11 is a drawing illustrating a portion of the internal structure of the wiring resin substrate according to a first embodiment of the invention. This wiring resin substrate 1 is formed into a rectangular shape (having a length and a breadth of 50 mm and a thickness of 1 mm) in a top plan view. On one principal face 12, as entirely illustrated in a schematic diagram in FIG. 4, there are formed a number of connection pads 121 for mounting connection terminals to be connected with the connection portions of an external device such as a mother board. On the other principal face, there are formed a number of electrodes 111 for connecting a semiconductor integrated circuit element IC to be mounted. In the internal structure of the wiring resin substrate 1, on the other hand, internal wiring layers 4, 5 and 7 and resin layers 3 are stacked on a core substrate 2 (as will be described hereinafter), and connection portions (or via conductors) 6 are formed in the resin layers 3 so as to connect the individual internal wiring layers with each other. FIGS. 1 and 2 are enlarged views of FIG. 4 on either of the principal faces of the core substrate 2.

The core substrate 2 is provided with through holes 21 of a diameter of about 150 μm (preferably, 100 μm to 350 μm), which are formed at an interval of about 500 μm (preferably, 200 μm to 800 μm) through a substrate material 25 made of a resin material such as a BT resin and having a thickness of about 0.8 mm (preferably, 0.3 mm to 1.2 mm)); through hole conductors 22 made of a metallic material such as copper and formed on the inner circumferences of the through holes 21 and in a substantially cylindrical shape (having a thickness of about 25 μm, preferably 10 μm to 50 μm); and a filling material 23 filling the hollow portions of the through hole conductors 22 and made of a resin material such as an epoxy resin, an epoxy acrylate resin, an acrylic resin or a polyimide resin. On the principal face of the core substrate 2, there is formed a wiring stacked portion 8, which is composed of the conductor layers 4 and 5 and resin layers 31, 32 and 33.

On the surface of the core substrate, specifically, there is formed the cover-shaped conductor layer 4, which has a shape containing the end portions of the through holes 21 so that it comes into conduction to the through hole conductors 22. The cover-shaped conductor layer 4 is made of a metallic material such as copper and hag a thickness of about 30 μm (preferably, 15 μm to 150 μm). On the cover-shaped conductor layer 4, moreover, there are formed the plurality of resin layers 3, which are made of a resin material such as an epoxy resin, a fluorine-containing resin or a BCB (Benzo Cyclo Butene). The thicknesses of the individual resin layers are set to about 30 μm (preferably, 20 μm to 180 μm), for example. Between the resin layers, moreover, there is formed the internal conductor layer 5, which is made of a metallic material such as copper. In this embodiment, the two resin layers 31 and 32 are sandwiched between the cover-shaped conductor layer 4 and the internal conductor layer 5, and they should not be limited to the two layers but may be one layer or three or more layers. In the resin layers 31 and 32 sandwiched between the cover-shaped conductor layer 4 and the internal conductor layer 5, respectively, there are buried via conductors 61 and 62 for bringing those conductors into conduction to form the connection portion 6. Here, the via conductors 61 and 62 are individually arranged to avoid the positions above the through holes 21.

In this embodiment, the via conductor 61 buried in the lower side resin layer 31 is made of a conformal via, and the via conductor 62 buried in the upper side resin layer 32 is made of a filled via. The conformal via 61 is provided with: a metallic material 612 composed mainly of copper and arranged along the wall of the via hole formed through the resin layer; a resin material 613 made of the same component as that of the resin layer 3 for filling the remaining portion; and a connection layer 614 extended and connected to the filled via 62. Moreover, this filled via 62 is formed by filling the via hole formed through the resin layer, with a metallic material composed mainly of copper. The conformal via 61 and the filled via 62 are constructed to have the maximum diameter of about 75 μm, for example. However, the diameter of the conformal via 61 is regulated by the portion (i.e., the inside of the via hole), which does not contain the connection layer 614. Moreover, the distances L61 and L62 from the center axes to the via conductors 61 and 62 composing the connection portion 6 to the outer edge of the through holes 21 are individually set to 125 μm or more and 500 μm or less.

Here will be described a second embodiment of the wiring resin substrate of the invention. FIG. 12 is a diagram illustrating a portion of the internal structure of a wiring resin substrate 101 according to the second embodiment. The following description is made mainly on those different from the first embodiment, and is simplified on the common portions by designating them by the common reference numerals in FIG. 12. In the wiring resin substrate 101 according to the second embodiment, as illustrated in FIG. 12, the via conductors 61 and 62 made of the filled vias are buried in the resin layers 31 and 32, respectively, and are substantially concentrically stacked at positions avoiding those above the through holes 21 thereby to construct the connection portion 6 of the stacked via structure. As a consequence, it is possible to spare the space and to retain the wiring area. Moreover, the distance L6 from the center axis of the via conductors 61 and 62 forming the connection portion 6 (i.e., the center axis of the stacked vias) to the outer edge of the through holes 21 is set to 125 μm or more and 500 μm or less.

An applied example of the wiring resin substrate of the invention will be described with reference to the accompanying drawings. FIGS. 1 and 2 are diagrams illustrating a portion of the internal structures of wiring resin substrates 201 and 301. FIG. 1 illustrates a strip line structure, and FIG. 2 illustrates a coplanar structure. These wiring resin substrates 201 and 301 are formed into a rectangular shape (having a length and a breadth of 50 mm and a thickness of 1 mm) in a top plan view. On one principal face 12, as entirely illustrated in a schematic diagram in FIG. 4., there are formed a number of connection pads 121 for mounting connection terminals to be connected with the connection portions of an external device such as a mother board. On the other principal face, there are formed a number of electrodes 111 for connecting a semiconductor integrated circuit element IC to be mounted. In the internal structures of the wiring resin substrates 201 and 301, on the other hand, internal wiring layers 4, 5 and 7 and resin layers 3 are stacked an a core substrate 2 (as will be described hereinafter), and connection portions (or via conductors) 6 are formed in the resin layers 3 so as to connect the individual internal wiring layers with each other. FIGS. 1 and 2 are enlarged views of FIG. 4 on either of the principal faces of the core substrate 2.

The core substrate 2 is provided with: through holes 21 of a diameter of about 150 μm, which are formed at an interval of about 500 μm through a substrate material 25 made of a resin material such as a BT resin and having a thickness of about 0.8 mm; through hole conductors 22 made of a metallic material such as copper and formed on the inner circumference of the through holes 21 and in a substantially cylindrical shape (having a thickness of about 25 μm); and a filling material 23 filling the hollow portions of the through hole conductors 22 and made of a resin material such as an epoxy resin, an epoxy acrylate resin, an acrylic resin or a polyimide resin. On the surface of the core substrate, there is formed the earthing conductor layer 4, which has a shape containing the end portions of the through holes 21 so that it comes into conduction to the through hole conductors 22. The earthing conductor layer 4 is made of a metallic material such as copper and has a thickness of about 30 μm (preferably, 15 μm to 50 μm).

On the earthing conductor layer 4, moreover, there are formed the plurality of resin layers 3, which are made of a resin material such as an epoxy resin, a fluorine-containing resin or a BCB (Benzo Cyclo Butene). Here, the plurality of resin layers 3 are composed of the two layers of the lower side resin layer 31 and the upper side resin layer 32, and should not be limited to those two layers but may be composed of three or more layers. The thicknesses of the individual resin layers are set to about 30 μm (preferably, 20 μm to 180 μm), for example. On the upper side resin layer 32, moreover, there is formed the second earthing conductor layer 5, which is made of a metallic material such as copper. Between the lower side resin layer 31 and the upper side resin layer 32, there is formed the transmission line 7, which has a width of about 30 μm and a thickness of about 30 μm (preferably 15 μm to 50 μm, individually) and which is positioned in the area between the first earthing conductor layer 4 and the second earthing conductor layer 5. Thus, FIG. 1 presents the strip line structure. In FIG. 2, the third earthing conductor layer 8 (or the earthing conductor line), which is made of a metallic material such as copper to have a width of about 30 μm and a thickness of about 30 μm (preferably, 15 μm to 50 μm, individually), is formed at a predetermined distance (e.g., 30 μm, preferably 10 μm to 100 μm) from the two sides of the transmission line 7 in the plane common to the transmission line 7 (between the lower side resin layer 31 and the upper side resin layer 32), so that the coplanar structure is presented.

In the structure thus far described, according to the embodiment of the wiring resin substrate of the invention, the connection portion 6 is formed to make the first earthing conductor layer and the second earthing conductor layer. The filled vias composing the connection portion 6 is individually formed in a substantially cylindrical shape having the maximum diameter of about 75 μm (preferably 25 μm to 100 μm). In the strip line structure of FIG. 1, the connection portion 6 is composed of the filled vias (i.e., the lower side 61 and the upper side 62), which are individually buried in the plurality of resin layers 3). These two filled vias 61 and 62 construct the stacked vias, in which they are concentrically contiguous to each other at a position of about 150 μm (preferably within a range of not less than 125 μm but not more than 500 μm), for example, from the outer edge end of the through holes 21. The lower filled via 61 is connected to the upper side principal face 41 of the first conductor layer 4, and the upper side filled via 62 is connected to the lower side principal face 51 of the second conductor layer 5.

In the coplanar structure of FIG. 2, the connection portion 6 is composed of the filled vias (i.e., the upper side 62 and the lowerside 61) and the third earthing conductor layer (i.e. the earthing conductor line) 8, which are individually buried in the plurality of resin layers 3, and the two filled vias 61 and 62 are concentrically arranged and are connected through the third earthing conductor layer (or the earthing conductor line). The lower side filled via 61 is connected to the upper side principal face 41 of the first conductor layer 4, and the upper filled via 62 is connected to the lower side principal face 51 of the second conductor layer 5. In the coplanar structure, moreover, the third earthing conductor layers (or the earthing conductor lines) 8 are arranged on the two sides of the transmission line 7 so that the two connection portions 6 exist on the two sides of the single transmission line 7. The conductor layer 8 closer to the through hole 21 is positioned at a distance of about 500 μm, for example, from the outer edge end of the through hole 21.

Here, the wiring resin substrate of the intention is manufactured by the well-known build-up technique (e.g., the subtractive method, the additive method or the semi-additive method), as described in Patent Publication 3 (JP-A-2000-307220, Paragraphs [0014 and 0015]) or Patent Publication 4 (JP-A-2000-34051, Paragraphs [0014 and 0015]).

### EXAMPLES

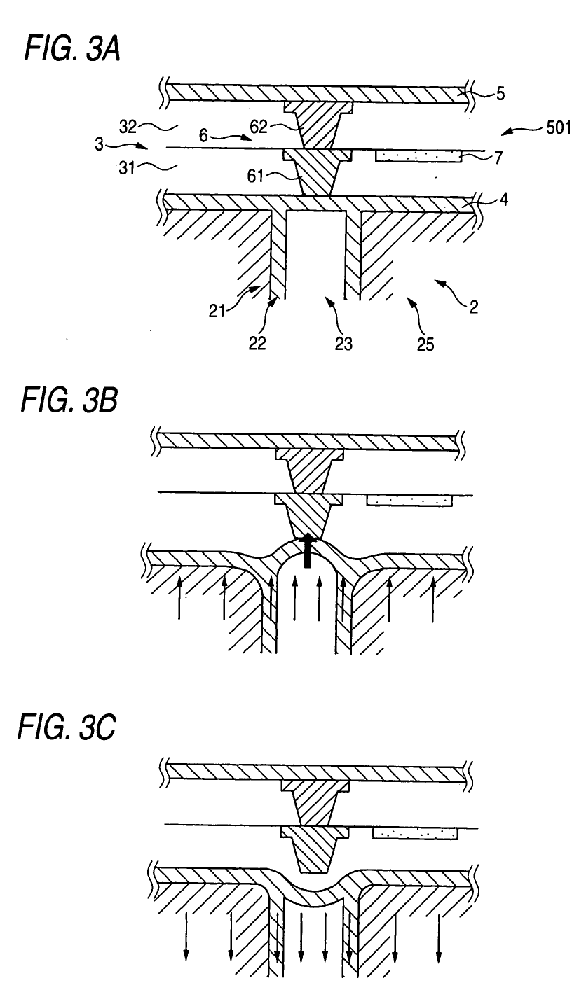

Here will be described a specific example of the wiring resin substrate of the invention together with its comparison. In Example 1 and Comparison 1, the wiring resin substrate 201 having the aforementioned strip line structure of FIG. 1 was exemplified by a wiring resin substrate 501, in which the connection portion made of the via conductor illustrated in FIG. 3 was arranged on the center axis above the through hole.

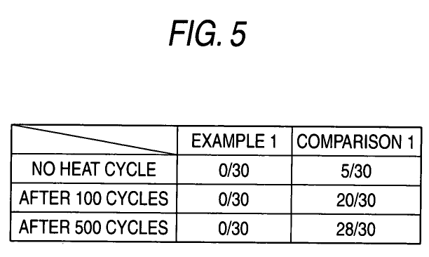

Fox Example 1 and Comparison 1, there were individually prepared three kinds of samples: \hat{1} before; \hat{2} 100 cycles after; and \hat{3} 500 cycles after a heat cycle (for ten minutes per cycle), in which a heating and a cooling were repeated in the temperature range of −55° C. to 125° C., and section SBM (Scanning Electron Microscope) observations were performed to evaluate the cracking percentages. These evaluation results are tabulated in FIG. 5. In FIG. 5, the denominators of the cracking percentages indicate the total number of samples, and the numerators indicate the number of cracked samples.

According to the evaluation results of FIG. 5, no fault such as the cracking was found in the SEM images of all the samples of Embodiment 1 of \hat{1} before the heat cycle, \hat{2} after 100 cycles and \hat{3} after 500 cycles. In Comparison 1, on the contrary, the cracking was found in one half of or more samples \hat{2} after 100 cycles and \hat{3} after 500 cycles. Moreover, it was found that some of the samples of \hat{1} before the heat cycle had already been cracked. It seems that the cracking was caused by the heat treatment at the manufacturing time.

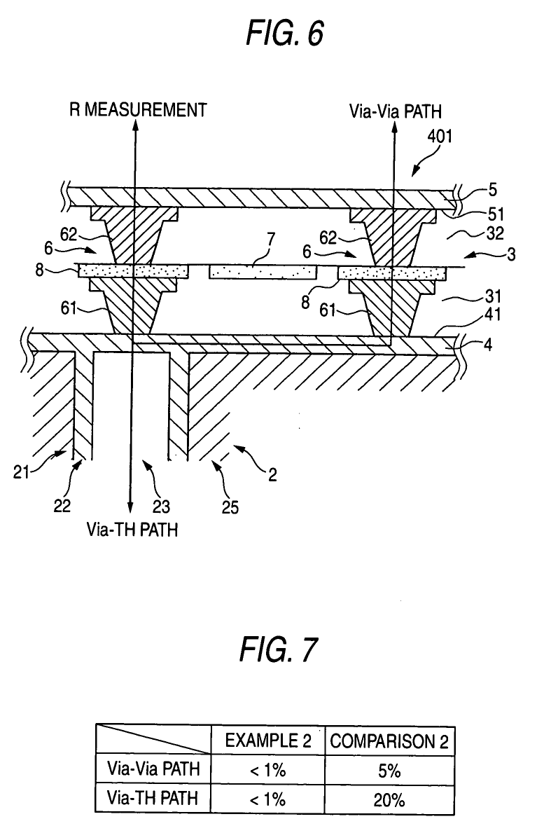

Next, Example 2 was exemplified by the wiring resin substrate 301 having the coplanar structure of FIG. 2, and Comparison 2 was exemplified by a wiring resin substrate 401 having gone side connection portion 6 positioned above the through hole, as illustrated in FIG. 6. In the conductor arranged to enclose the transmission line 7, as illustrated in FIGS. 2 and 6, the resistance changing rates before and after (i.e., after 100 cycles) the heat cycle were measured on the two paths: the path (i.e., the Via-Via path) from one connection portion 6 through the first earthing conductor layer 4 to the other connection portion 6; and the path (i.e., the Via-TH path from the connection portion 6 positioned above the through hole 21 in the case of Comparison 2) from one connection portion 6 through the first earthing conductor layer 4 and the through hole conductors 22. However, the conditions for the heat treatment were similar to the aforementioned conditions, and the resistance changing rates are defined by (the resistivity after the heat cycle—the resistivity before the heat cycle)/(the resistivity before the heat cycle). The measurement results are tabulated in FIG. 7.

According to the measurement results of FIG. 7, the resistance changing rate of Example 2 was less than 1%, and both the Via-Via path and the Via-TH path were hardly changed before and after (i.e. after 100 cycles) the heat cycle. On the contrary, the resistance changing rate of Comparison 2 was 5% for the Via-Via path and 20% for the Via-TH path, and the changes were found before and after (i.e., after 100 cycles) the heat cycle. This is caused because of the following reasons. In Comparison 2, the connection portion 6 was positioned above the through hole 21 so that a fatigue or cracking occurred on either the joint face between the connection portion 6 and the first earthing conductor layer or the second earthing conductor layer 5 or the joint face between the conductors (i.e., the via conductors 61 and 62 and the third earthing conductor layer (or the earthing conductor line) 8) by the push/pull of the through hole 21, as accompanying the expansion/shrinkage of the core substrate 2, thereby to raise the resistivity after the heat cycle.

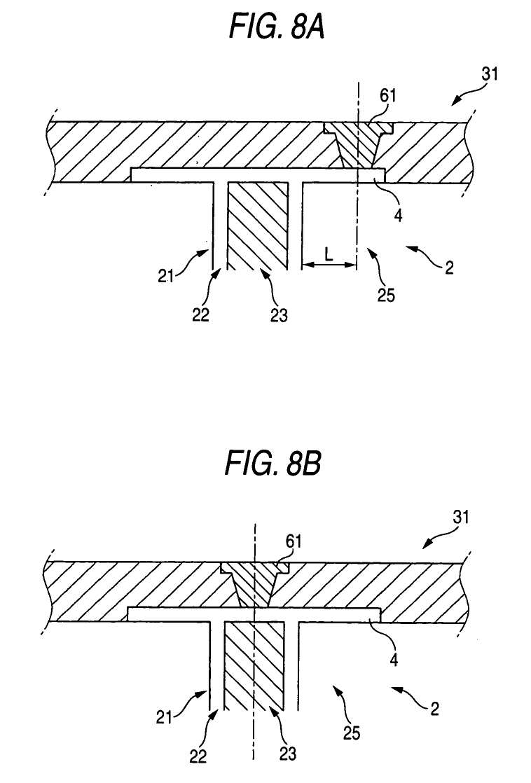

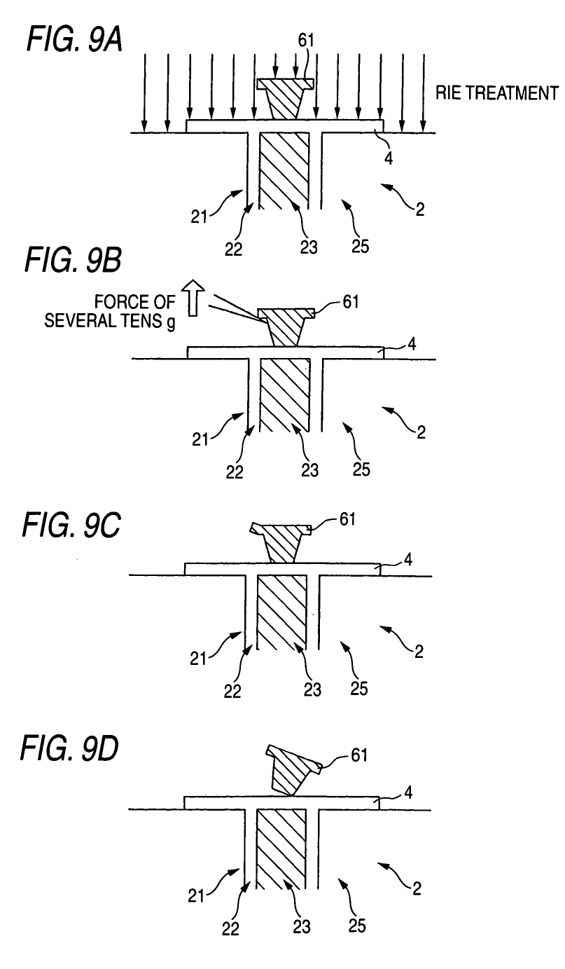

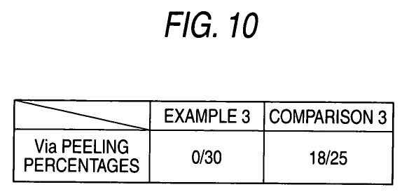

Next, there was prepared a sample, in which only the first earthing conductor layer 4, the lower side resin layer 31 and the lower side filled via 61 were formed over the core substrate 2. In Example 3, a distance L from the center axis of the filled via 61 to the outer edge end of the through hole 21 was set at 150 μm, as illustrated in FIG. 8A. In Comparison 3, the filled via 61 was arranged on the center axis of the through hole 21. Then, the heat treatment under the aforementioned conditions was applied for 100 cycles. After this, the RIE (Reactive Ion Etching) was applied, as illustrated in FIG. 9A, to remove the lower side resin layer 31. After this, a stainless needle was applied to the lower side of the diametrically larger portion of the filled via 61 and was pulled vertically upward with a force of several tens g. The via joints were evaluated by accepting the case, in which the filled via 61 did not peel off the first earthing conductor layer 4 but only the diametrically larger portion was deformed, as illustrated in FIG. 9C, and by rejecting the case, in which the filled via 61 peeled off the first earthing conductor layer 4, as illustrated in FIG. 9D. The evaluation results were tabulated in FIG. 10. In FIG. 10, the denominators of the via peeling percentages indicate the total number of samples, and the numerators indicate the number of rejected samples.

According to the evaluation results of FIG. 10, no peel of the filled via 61 was found in Example 3 for all the samples. In Comparison 3, on the contrary, the peel of the filled via 61 was found for about one half of the samples. This is caused because of the following reasons. In Comparison 3, the filled via 61 was positioned above the through hole 21 so that a fatigue or cracking occurred on the joint face between the filled via 61 and the first earthing conductor layer 4 by the push/pull of the through hole 21, as accompanying the expansion/shrinkage of the core substrate 2, so that the filled via 61 became easy to peel off.

This application is based on Japanese Patent application JP 2003-54477, filed Feb. 28, 2003, and Japanese Patent application JP 2004-23495, filed Jan. 30, 2004, the entire contents of those are hereby incorporated by reference, the same as if set forth at length.

What is claimed is:

1. A wiring substrate, in which a wiring stacked portion including a conductor layer and a resin layer is stacked on a principal face of a core substrate including a substantially cylindrical through hole conductor in a through hole extending therethrough and a filling material filling the hollow portion of said through bole, comprising:
a cover-shaped conductor portion covering an end face of said through hole just over a principal face of said core substrate and connected to said through hole conductor; and
an internal conductor layer provided in said wiring stacked portion and across at least one of said resin layer from said cover-shaped conductor layer,
wherein a connection portion composed of via conductors buried in said resin layer brings said cover-shaped conductor portion and said internal conductor layer into conduction, and
said via conductors composing said connection portion are provided not above said through hole.

2. The wiring substrate according to claim 1, wherein at least two of said resin layer are sandwiched between said cover-shaped conductor layer and said internal conductor layer, and
said via conductor composed of filled vias is buried in each of said resin layer and is stacked substantially concentrically in plurality to construct said connection portion.

3. The wiring substrate according to claim 1, wherein a distance from a center axis of said via conductor constructing said connection portion to an outer edge of said through hole is from 125 μm to 500 μm.

4. The wiring substrate according to claim 2, wherein a distance from a center axis of said via conductor constructing said connection portion to an outer edge of said through hole is from 125 μm to 500 μm.

5. A wiring substrate comprising:
a core substrate including a through hole provided through an insulating substrate, a substantially cylindrical through hole conductors provided on an inner circumference of said through hole, and a filling material filling a hollow portion of said through hole conductors;
a first earthing conductor layer provided on at least one principal face of said core substrate and in a shape containing an end face of said through hole and having conduction to said through hole conductor;
a plurality of resin layers provided over said first earthing conductor layer;
a transmission line provided between any ones of said resin layers and positioned above said first earthing conductor layer;
a second earthing conductor layer provided over said resin layers and in a shape containing said transmission line; and
a connection portion including either: via conductors buried individually in said resin layers; or said via conductors and a third earthing conductor layer provided between the same resin layers as said transmission line and having no conduction to said transmission line, said via conductors being provided to bring said first earthing conductor layer and said second earthing conductor layer into conduction,
wherein said via conductors to be connected to said first earthing conductor layer are positioned in said connection portion so as not to be above said through hole.

6. The wiring substrate according to claim 5, wherein
either a stacked via structure, in which a plurality of filled vias are concentrically contiguous to each other at a position avoiding that above said through hole; or
a structure, in which said third earthing conductor layer is connected between any contiguous ones of said filled vias in said stacked via structure is provided.
